(19) United States
(12) Patent Application Publication
(10) Pub. No.: US 2005/0198181 A1
(43) Pub. Date: Sep. 8, 2005

(54) Method and apparatus to use a statistical model to classify electronic communications

(76) Inventor: Jordan Ritter, San Francisco, CA (US)

Correspondence Address: John P. Ward;BLAKELY, SOKOLOFF, TAYLOR & ZAFMAN LLP, Seventh Floor, 12400 Wilshire Boulevard, Los Angeles, CA, 90025, US

(21) Appl. No.: 11/071,385

(22) Filed: Mar. 2, 2005

Related U.S. Application Data
(60) Provisional application No. 60/549,895, filed on Mar. 2, 2004.

(51) Int. Cl. G06F 15/16

(52) U.S. Cl. 709/206

(57) ABSTRACT

A method and apparatus to use a statistical model to classify electronic communications is disclosed. In one embodiment, an incoming electronic communication is analyzed in view of a preformulated statistical model to determine whether the communication is to be classified within at least one predetermined category. In one embodiment, the statistical model includes a set of features relating to an electronic communication.

This application claims the benefit of co-pending U.S. Provisional Patent Application No. 60/549,895, which was filed on Mar. 2, 2004; titled “A METHOD AND APPARATUS TO USE A STATISTICAL MODEL TO CLASSIFY ELECTRONIC COMMUNICATIONS” (Attorney Docket No. 6747.P002Z) which is incorporated herein by reference.

### FIELD OF THE INVENTION

This invention relates to a method and apparatus to use a statistical model to classify electronic communications.

### BACKGROUND

As used herein, the term “spam” refers to electronic communication that is not requested and/or is non-consensual. Also known as “unsolicited commercial e-mail” (UCE), “unsolicited bulk e-mail” (UBE), “gray mail” and just plain “junk mail”, spam is typically used to advertise products. The term “electronic communication” as used herein is to be interpreted broadly to include any type of electronic communication or message including voice mail communications, short message service (SMS) communications, multimedia messaging service (MMS) communications, facsimile communications, etc.

The use of spam to send advertisements to electronic mail users is becoming increasingly popular. Like its paper-based counterpart-junk mail, receiving spam is mostly undesired.

Therefore, considerable effort is being brought to bear on the problem of filtering spam before it reaches the in-box of a user.

Currently, rule-based filtering systems that use rules written to filter spam are available. As examples of the rules, consider the following rules:
(a) “if the subject line has the phrase “make money fast” then mark as spam;” and
(b) “if the sender field is blank, then mark as spam.”

Usually thousands of such specialized rules are necessary in order for a rule-based filtering system to be effective in filtering spam. Each of these rules is typically written by a human, which adds to the cost of rule-based filtering systems.

Another problem is that senders of spam (spammers) are adept at changing spam to render the rules ineffective. For example consider the rule (a), above. A spammer will observe that spam with the subject line “make money fast” is being blocked and could, for example, change the subject line of the spam to read “make money quickly.” This change in the subject line renders rule (a) ineffective. Thus, a new rule would need to be written to filter spam with the subject line “make money quickly.” In addition, the old rule (a) will still have to be retained by the system.

With rule-based filtering systems, each incoming electronic communication has to be checked against thousands of active rules. Therefore, rule-based filtering systems require fairly expensive hardware to support the intensive computational load of having to check each incoming electronic communication against the thousands of active rules. Further, intensive nature of rule writing adds to the cost of rule-based systems.

Another approach to fighting spam involves the use of a statistical classifier to classify an incoming electronic communication as spam or as a legitimate electronic communication. This approach does not use rules, but instead the statistical classifier is tuned to predict whether the incoming communication is spam based on an analysis of words that occur frequently in spam. While the use of a statistical classifier represents an improvement over rule-based filtering systems, a system that uses the statistical classifier may be tricked into falsely classifying spam as legitimate communications. For example, spammers may encode the body of an electronic communication in an intermediate incomprehensible form. As a result of this encoding, the statistical classifier is unable to analyze the words within the body of the electronic communication and will erroneously classify the electronic communication as a legitimate electronic communication. Another problem with systems that classify electronic communications as spam based on an analysis of words is that legitimate electronic communications may be erroneously classified as spam if a word commonly found in spam is also used in the legitimate electronic communication.

### SUMMARY OF THE INVENTION

A method and apparatus to use a statistical model to classify electronic communications is disclosed. In one embodiment, an incoming electronic communication is analyzed in view of a preformulated statistical model to determine whether the communication is to be classified within at least one predetermined category. In one embodiment, the statistical model includes a set of features relating to an electronic communication.

### BRIEF DESCRIPTION OF THE DRAWINGS

FIG. 1 presents a flowchart describing the processes of using a statistical model to classify an electronic communication, in accordance with one embodiment of the invention;

FIG. 2 presents a flow diagram of providing a user with the capability to define a predetermined actions/processing to be performed on the electronic communication based on the confidence level;

FIG. 3 shows a high-level block diagram of hardware capable of implementing the present invention, in accordance with one embodiment.

### DETAILED DESCRIPTION

Embodiments of the present invention provide a method and apparatus to use a statistical model to classify electronic communications. In one embodiment, the statistical model within a statistical classifier is used to classify incoming electronic communications as spam or as legitimate electronic communications based on a set of features that relates to a structure of the communication.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

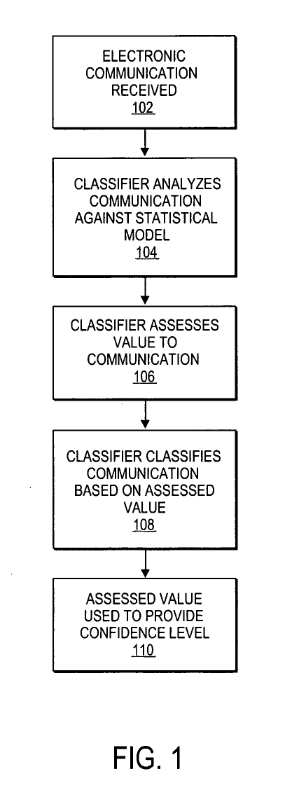

FIG. 1 presents a flow diagram describing the process of using a statistical model in a classifier to classify electronic communications, into at least one predetermined category, in accordance with one embodiment. In process 102, an electronic communication is received. An electronic communication transfer agent, such as a mail server, or similar unit, may receive the communication.

In process 104, a classifier analyzes the communication in comparison with a preformulated statistical model. In one embodiment, the statistical model includes a preformulated set of electronic communication structural features, which are used to classify communication into a predetermined category, such as spam or legitimate. For example, in one embodiment, the predetermined features relate to changes or mutations to a structure of an electronic communication (e.g., a header of an electronic communication, and/or a body of an electronic communication). In one embodiment, the features relate to the structure of an electronic communication as opposed to individual words in the content of the electronic communication.

The presence of one or more of the predetermined features may indicate the communication is more likely to be of a specific predetermined category (e.g., spam or legitimate.) In one embodiment, the features of the statistical model have associated predetermined values, corresponding to one or more predetermined categories. For example, if feature X is detected in the communication, the feature may have an associated value of 25% for spam, and value of 5% for legitimate communications (i.e., the associated values of X indicating the feature X is more frequently found in Spam).

In one embodiment, there are several features in the statistical model, the actual number of features, the values, and the specific features may vary within the scope of the invention. One example of generating a statistical model can be found in the co-pending application entitled “Method and Apparatus To Use A Genetic Algorithm To Generate A Statistical Model,” filed on ______, Ser. No. ______, assigned to applicant, and incorporated herein by reference.

In process 106, the classifier assesses at least one value to the communication based on the analyzing of the communication against the statistical model. In one embodiment, multiple values may be assessed in the case of classifying the communication into one of multiple categories, such as spam and legitimate communication.

In process 108, the classifier classifies the communication in accordance with the assessed value. For example, in one embodiment, in the case of classifying the communication into one of multiple categories, the communication is classified into the category that has the highest value, (or possibly lowest, depending up implementation.) In an alternative embodiment, in the case of determining whether the communication is to be classified into a single category, the classifier compares the assessed value with a predetermined threshold, to determine if the communication is to be classified in the predetermined category (e.g., spam). In yet other alternative embodiments, alternative processes may use the assessed value(s) in other ways to classify the communication, without departing from the invention.

In process 110, in one embodiment, the assessed value used to classify the communication in process 108, is used to provide a confidence level (i.e., an indicator of the certainty of the classification of the communication.) The confidence level may be used to initiate one of set of predetermined processing of the communication, as is described in more detail below.

More specifically, in one embodiment, the classifier may be configured to provide a user (such as a system administrator) with a capability to define a predetermined action/processing of the electronic communication based on a confidence level of the communication. For example, in one embodiment, the predetermined action may include rejecting, dropping, or tagging the incoming electronic communication. When rejecting the incoming electronic communication, delivery thereof to the intended recipient is refused, and an error message is sent back to the sender of the incoming electronic communication. When dropping the incoming electronic communication, delivery thereof is refused, but no error message is sent back to the sender of the incoming electronic communication. Tagging the incoming electronic communication, includes modifying the incoming electronic communication, for example, with a prefix to indicate that the electronic communication is likely to be of a specific category.

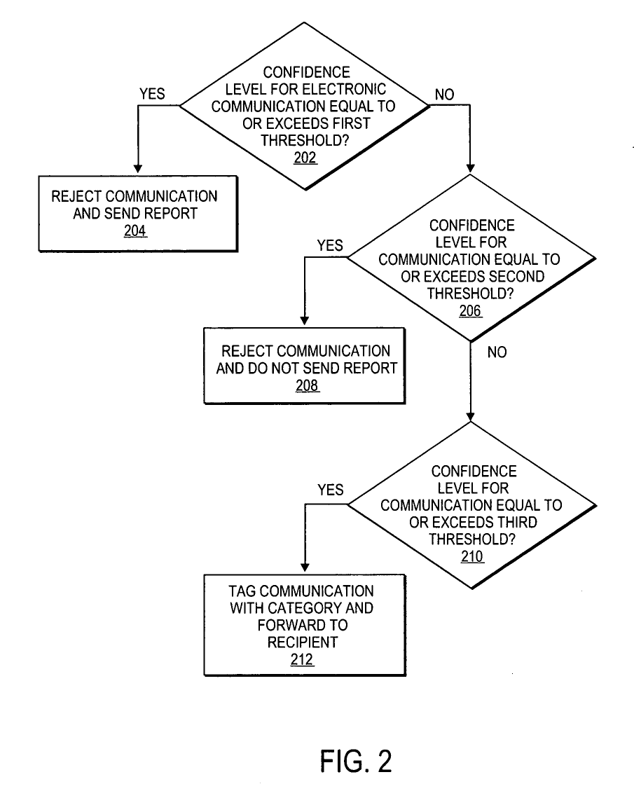

Referring to FIG. 2, a flow diagram is presented describing an exemplary embodiment of the processes of providing a user with the capability to define a predetermined actions/processing of an electronic communication based on the confidence level. In process 202, the confidence level generated in process 110, as described above, is compared with a first predetermined threshold. If the confidence level is equal to or exceeds the first predetermined threshold, in process 204 delivery of the electronic communication to an intended recipient is rejected, and an error report is sent to a sender of the electronic communication to indicate that delivery was rejected.

If the confidence level is below the first predetermined threshold, in process 206 the confidence level is compared to a second predetermined threshold. If confidence level is equal to or greater than the second predetermined threshold, in process 208, delivery of the electronic communication to an intended recipient is rejected, and an error report is not sent to a sender of the electronic communication to indicate that delivery was rejected.

If the confidence level is below the first and second predetermined thresholds, in process 210 the confidence level is compared to a third predetermined threshold. If confidence level is equal to or greater than the third predetermined threshold, in process 212, the electronic communication is modified to indicate that the communication has been classified as a member of the predefined category, and delivered as modified to an intended recipient. In alternative embodiments, more or less thresholds may be used to define more or less actions and/or processing to perform on the communications, without departing from the scope of the invention.

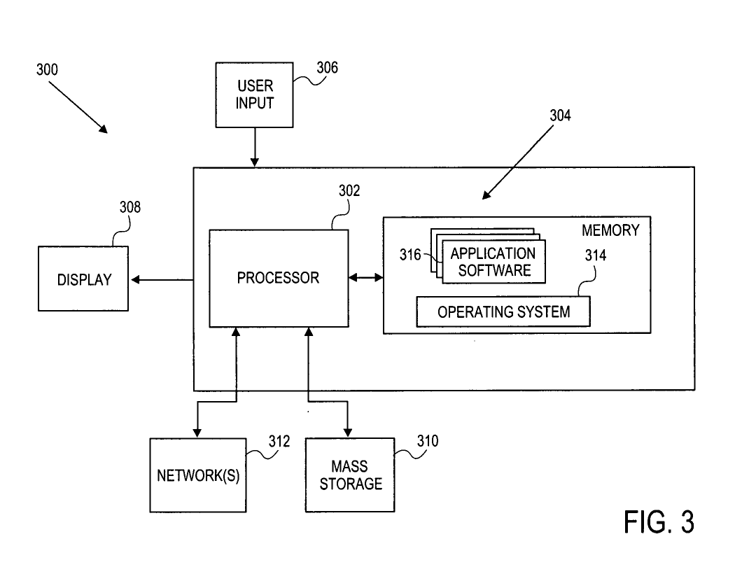

Referring to FIG. 3 of the drawings, reference numeral 300 generally indicates hardware that may be used to implement an electronic communication transfer agent server in accordance with one embodiment. The hardware 300 typically includes at least one processor 302 coupled to a memory 304. The processor 302 may represent one or more processors (e.g., microprocessors), and the memory 304 may represent random access memory (RAM) devices comprising a main storage of the hardware 300, as well as any supplemental levels of memory e.g., cache memories, non-volatile or back-up memories (e.g. programmable or flash memories), read-only memories, etc. In addition, the memory 304 may be considered to include memory storage physically located elsewhere in the hardware 300, e.g. any cache memory in the processor 302, as well as any storage capacity used as a virtual memory, e.g., as stored on a mass storage device 310.

The hardware 300 also typically receives a number of inputs and outputs for communicating information externally. For interface with a user or operator, the hardware 300 may include one or more user input devices 306 (e.g., a keyboard, a mouse, etc.) and a display 308 (e.g., a Cathode Ray Tube (CRT) monitor, a Liquid Crystal Display (LCD) panel).

For additional storage, the hardware 300 may also include one or more mass storage devices 310, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 300 may include an interface with one or more networks 312 (e.g., a local area network (LAN), a wide area network (WAN), a wireless network, and/or the Internet among others) to permit the communication of information with other computers coupled to the networks.

The processes described above can be stored in the memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that the various modifications and changes can be made to these embodiments without departing from the broader spirit of the invention as set forth in the claims, Accordingly, the specification and drawings are to be regarded in an illustrative sense rather than in a restrictive sense.

1) A method comprising:
defining a set of one or more features, including characteristics of an electronic communication.
defining a statistical model comprising of one or more of the features;
populating the statistical model with weighted probabilities for each of the one or more features, based on one or more predetermined categories;
reducing an electronic communication to a corresponding representation of features based upon the statistical model; and
classifying the electronic communication into one of the one or more categories represented by the statistical model.

2) The method of claim 1, wherein the characteristics of an electronic communication are structural elements.

3) The method of claim 2, wherein the structural elements comprise formatting, routing or rendering controls associated with the electronic communication.

4) The method of claim 1, wherein the structural elements are communication routing elements.

5) The method of claim 4, wherein the routing elements are RFC822 email headers associated with the electronic communication.

6) The method of claim 2, wherein the structural elements are grammatical language constructs.

7) The method of claim 2, wherein the structural elements are Universal Resource Identifiers (URIs).

8) The method of claim 2, wherein the structural elements are content encoding formats.

9) The method of claim 2, wherein the structural elements are communication construction controls.

10) The method of claim 2, wherein the structural elements are content packaging formats.

11) The method of claim 1, wherein the characteristics are structural anomalies of the electronic communication.

12) The method of claim 11, wherein structural anomalies are violations of applicable RFC standards applicable to the electronic communication.

13) The method of claim 11, wherein structural anomalies are methods that change the expected rendering of the electronic communication.

14) The method of claim 1, wherein reducing an electronic communication to a corresponding representation of comprises includes determining the features from the statistical model that are present in the electronic communication.

15) The method of claim 14, wherein one or more feature present in the electronic communication are associated with one or more preconfigured statistical probabilities and associated with one or more predetermined categories.

16) The method of claim 15, further including generating a confidence level for the communication based on the statistical probabilities of the features present in the electronic communication.

17) The method of claim 16, wherein the confidence level is used to classify the electronic communication in one or more of the categories represented by the statistical model.

18) The method of claim 17, further includes providing a user with a capability to associate at least one predetermined action to take on the electronic communication based on the generated confidence level.

19) The method of claim 1 wherein the electronic communication is an electronic document.

20) The method of claim 1 wherein the electronic communication is an e-mail.

21) The method of claim 1 wherein the electronic communication is an electronic conversation between one or more parties.

22) The method of claim 1 wherein the electronic communication is an image.

23) A machine-readable medium having stored thereon a set of instructions which when executed cause a system to perform a method comprising of:
defining a set of one or more features, including characteristics of an electronic communication.
defining a statistical model comprising of one or more of the features;
populating the statistical model with weighted probabilities for each of the one or more features, based on one or more predetermined categories;
reducing an electronic communication to a corresponding representation of features based upon the statistical model; and
classifying the electronic communication into one of the one or more categories represented by the statistical model.

24) A system comprising:
a processor;
a network interface coupled to the processor; and
a means for defining a set of one or more features, including characteristics of an electronic communication.
a means for defining a statistical model comprising of one or more of the features;
a means for populating the statistical model with weighted probabilities for each of the one or more features, based on one or more predetermined categories;
means for reducing an electronic communication to a corresponding representation of features based upon the statistical model; and
a means for classifying the electronic communication into one of the one or more categories represented by the statistical model.
